(19) United States
(12) Patent Application Publication
(10) Pub. No.: US 2009/0162812 A1
(43) Pub. Date: Jun. 25, 2009

(54) DENTAL COMPOSITE SHAPING BURS

(75) Inventor: George Harouni, Henderson, NV (US)

Correspondence Address: TRAVIS CHANDLER, PHD, LLC, 1489 WEST WARM SPRINGS ROAD, SUITE 110, HENDERSON, NV, 89014, US

(73) Assignee: BHR PROJECT LLC, Henderson, NV (US)

(21) Appl. No.: 11/961,168

(22) Filed: Dec. 20, 2007

(51) Int. Cl. A61C 3/06

(52) U.S. Cl. 433/166

(57) ABSTRACT

A system of conically shaped dental burs mounted on the end of cylindrical shafts is disclosed. In one embodiment, the tip of the cone presents an abrasive surface, while the basal edge of the conical surface presents a smooth surface useful for limiting the overall penetration of the bur. This may be used for crafting grooves or fossae on dental surfaces. In an alternate embodiment the tip portion of the conical bur presents the smooth limiting surface, and the peripheral edges are abrasive, so that this bur is useful for reducing cusps or ridges. The burs are used with the axis of rotation perpendicular to the plane of the tooth. They used alternately by the dental practitioner in the detailed sculpting of dental composite fillings. The shaft portion incorporates finished shapes commonly used for either high speed or low speed bur drive systems.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to the field of dental tools, and more specifically to the field of dental grinding burs. The present invention specifically relates to a bur suitable for constructing the complex detailed surface of the occlusal face of a tooth where the natural surface has been replaced by dental composite filling.

### BACKGROUND OF THE INVENTION

In the practice of the dental arts, grinding bits or burs are used with power drive accessories to perform different tasks in reducing teeth for veneers or crowns, for removing decay, or for performing root canals. Other needs include boring natural teeth for the insertion of posts for securing crowns or of bone for installing implants. There generally exists a need not to grind too deeply into the tooth so as to preserve as much healthy material as may be practicable. While it has often fallen purely to the dexterity and manipulative skill of the dentist, assistance in performing dental excavations to limit the amount of material removed has long been a recognized need.

This need has been addressed by various devices disclosed in the prior art. Generally the prior art discloses self-limiting burs, where in addition to an abrasive part, part of the bur contains a smooth non-abrasive non-cutting surface that stops further penetration. However none of the prior art is well-suited for performing detailed sculpting of the finished surface of dental composites used in repairing teeth with dental caries. Notably, there is a need for such a dental bur to sculpt the biting or occlusal surface of teeth with dental composite fillings, particularly where applied to molars, so that a more natural occlusal surface is obtained that better matches the contours of the opposing teeth.

In U.S. patent application 20070238068, Comfortes discloses a bur that includes a spherical cutting element and a shield integrally placed behind the bur. The shield is circularly configured, has a rounded periphery and is provided with a smooth tooth-engaging surface. The shield insures that the depth of the penetration into the tooth is precisely predetermined. This bur relates to a method for reducing existing enamel or dentine as part of tooth preparation of porcelain veneers and porcelain crowns.

This is in contrast to U.S. Pat. No. 7,021,933, where Caldwell discloses a bur for depth reduction of dental surfaces that includes a smooth curved shoulder extending to a smaller diameter cylindrical abrasive bur. The smooth shoulder defines a stop for self-limiting the bur penetration depth into the enamel or ossiferous surfaces. This device is also intended for size reduction as part of tooth preparation of porcelain veneers and porcelain crowns.

In U.S. Pat. No. 6,511,322 Kometas discloses a self-limiting occlusal reduction bur comprising a shank rigidly attached to the larger end of a conical shoulder, and a cylindrical abrasive bur rigidly attached to the opposite narrow end of the shoulder. This device is also intended for size reduction as part of tooth preparation of veneers and crowns.

In U.S. Pat. No. 6,186,788 Massad discloses a set of burs for crafting cusps and grooves in the occlusal surfaces of prosthetic dentures comprising two conical portions on a common axis sloped away from a central cylindrical portion. The invention consists of two embodiments, where in one case the sloped conical sections carry an abrasive surface, and the cylindrical center portion is smooth and non-abrasive, and in the alternate embodiment the abrasive and non-abrasive surfaces are reversed. Both embodiments are used where the axis of rotation of the bur is approximately parallel to the plane of the occlusal surface of the denture.

Thus in the first embodiment, the conical abrasive surfaces may be used to reduce cusps, with the smooth central cylindrical portion resting in the grooves and fossae of the occlusal faces and providing a limiting function with respect to the depth of cusp material removal. In the second embodiment, the smooth conical portions provide the self-limiting function by resting against the cusps, while the abrasive central cylindrical portions remove material from the grooves and fossae of the occlusal faces of the denture.

Because of the complex natural patterns of the cusps and grooves on the occlusal surface of a tooth whereby they are aligned in many different directions, the invention of U.S. Pat. No. 6,186,788 is not generally suitable for use with a natural tooth in the mouth of a patient. The axis of rotation of the tool, approximately parallel to the occlusal plane of the tooth, limits the access of the tool to only some of the grooves and cusps, unless the tooth is removed from the patient. Thus the usefulness of the tool is generally limited to prosthetic dentures.

Additionally, the burs of U.S. Pat. No. 6,186,788 of are limited capability in the detail of the final surface that can be obtained, where only approximately straight grooves or cusps many be crafted. Thus for example, where a prosthetic denture is used in opposition to a natural tooth, with its curved and irregular cusps and grooves, the fit and comfort of the resulting bite is not optimal.

What is needed, but has not been disclosed in the prior art, is a bur for the detailed crafting of dental composite fillings for restoration of teeth with caries, such as where such composites are photochemically hardened and commonly used in the practice of the dental arts. What is particularly needed is a bur that is self-limiting with respect to depth of material removed, and capable of constructing irregular occlusal surfaces that form a superior match to the occlusal face of opposing teeth.

### SUMMARY OF THE INVENTION

The present invention comprises a set of conically shaped burs mounted on the end of a cylindrical shaft, wherein in one embodiment, the tip of the cone includes an abrasive surface and the basal edge of the conical surface presents a smooth surface suitable for limiting the overall penetration of the bur. This embodiment is useful for crafting grooves or fossae on the occlusal surfaces. In the alternate embodiment the tip portion of the conical bur presents the smooth limiting surface, and the peripheral edges are abrasive. This embodiment is useful for reducing cusps or ridges. The abrasive portions of the burs may be achieved by adhering diamond particles or powders to the base metal, or by other methods known in the art.

Both embodiments of the present invention are applied to the tooth with the axis of rotation approximately perpendicular to the occlusal plane of the teeth. Both embodiments are used alternately by the dental practitioner in the detailed sculpting of dental composite fillings for restoration of caries, especially including photochemically hardened composites. The burs may be used interchangeably with rotary power drives as are commonly used in the prior art. The shaft portion may incorporate finished shapes commonly used for either high speed drill drive systems, or alternately for the low speed systems.

### OBJECTS OF THE INVENTION

Several advantages are derived from this invention. It is an object of the present invention to provide a tool for the detailed crafting of dental composite fillings for the restoration of teeth with caries.

It is a further object to provide a tool that is self-limiting with respect to depth of material removed.

It is a further object to provide a tool that is capable of constructing irregular occlusal surfaces that form a superior match to the occlusal face of opposing teeth.

It is a further object to provide a tool with shaft portions suitable for use with either high speed drill drive systems, or alternately for low speed systems.

Other objects, features and advantages of the present invention will become apparent from the following description when taken in conjunction with the accompanying drawings wherein like characters of reference designate corresponding parts throughout the several views.

### BRIEF DESCRIPTION OF THE DRAWINGS

FIG. 1 illustrates a bur with an abrasive tip and a non-abrasive periphery, with a shaft for high speed operation.

FIG. 2 illustrates a bur with a non-abrasive tip and an abrasive periphery, with a shaft for high speed operation.

FIG. 3 illustrates a bur with an abrasive tip and a non-abrasive periphery, with a shaft for low speed operation.

FIG. 4 illustrates a bur with a non-abrasive tip and an abrasive periphery, with a shaft for low speed operation.

### DETAILED DESCRIPTION OF EXEMPLARY EMBODIMENTS

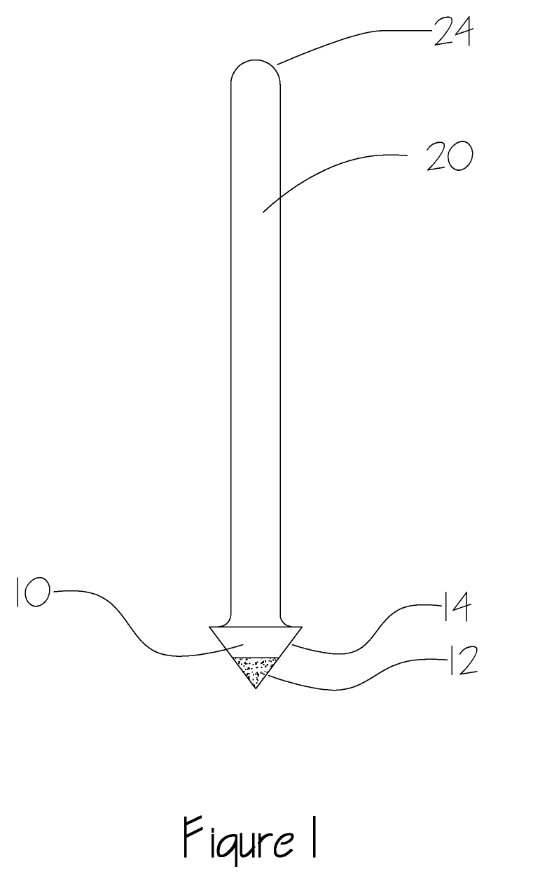

FIG. 1 illustrates one embodiment of the present invention comprising a conically shaped bur 10 attached coaxially to the distal end of a cylindrical shaft 20. In this embodiment the tip of the cone includes an abrasive surface 12 and the basal edge or periphery of the conical surface 14 presents a smooth surface suitable for limiting the overall penetration of the bur. This embodiment also includes a proximal shaft end 24 formed for commonly used power drive handsets or drills designed to operate at high speeds. This embodiment is useful for crafting grooves or fossae of the occlusal surfaces of the tooth.

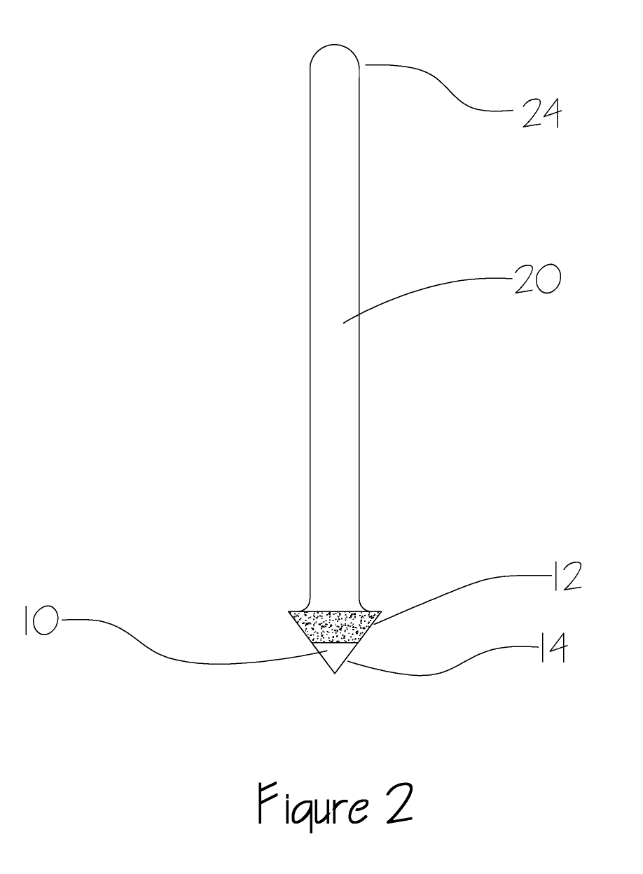

In an alternate embodiment as shown in FIG. 2, the tip portion of the conical bur 10 presents the smooth limiting surface 14, and the peripheral outward basal edges have the abrasive surface 12. This embodiment also includes a proximal shaft end 24 suitable for commonly used power drive handsets or drills designed to operate at high speeds. This embodiment of the present invention is useful for reducing cusps or ridges.

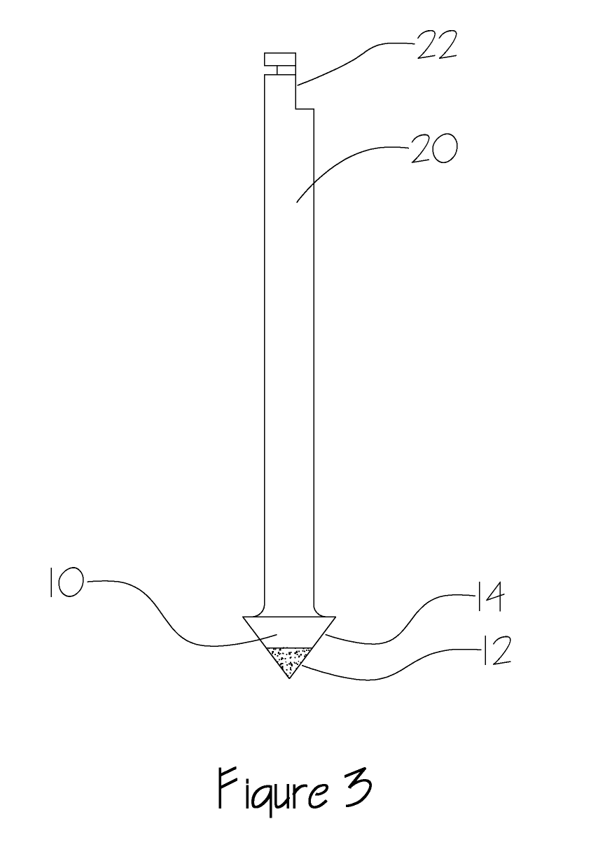

FIG. 3 illustrates an embodiment of the present invention comprising a conically shaped bur 10 attached coaxially to the distal end of a cylindrical shaft 20 where the tip presents an abrasive surface 12 and the peripheral outward basal portion presents a smooth non-abrasive surface 14. This embodiment also includes a proximal shaft end 22 formed for commonly used power drive handsets or drills designed to operate at low speeds.

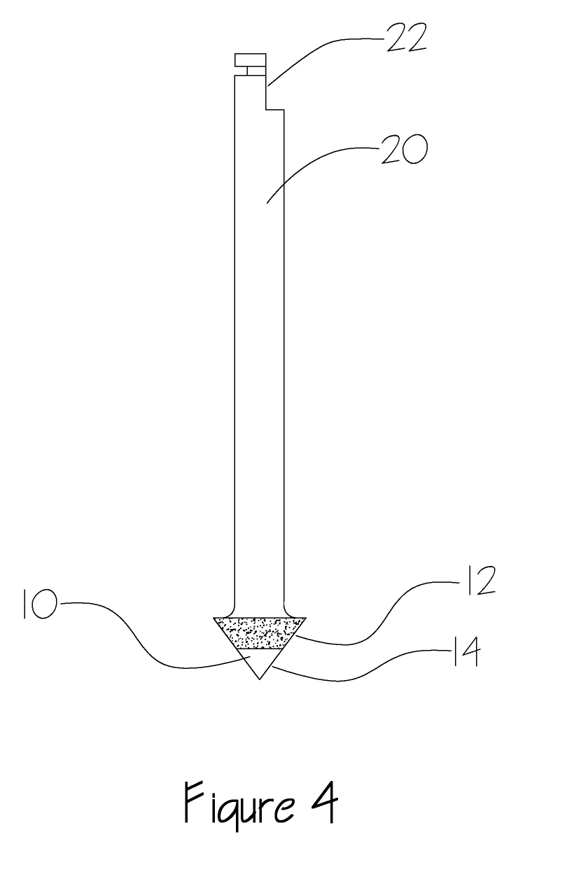

In FIG. 4, the tip portion of the conical bur 10 presents the smooth limiting surface 14, and the peripheral edges have the abrasive surface 12. This embodiment also includes a proximal shaft end 22 suitable power drive handsets or drills operating at low speeds.

In each embodiment, the burs of the present invention are most often applied to the tooth with the axis of rotation approximately normal or perpendicular to the approximate plane of the surface of the tooth to be sculpted. Typically this will be the occlusal surface of the tooth. The different embodiments may be used alternately by the dental practitioner in the detailed sculpting of dental composite fillings for restoration of caries, especially including photochemically hardened composites. The burs may be used interchangeably with rotary power drives as are commonly used in the prior art.

The abrasive portions of the burs may be achieved by adhering diamond particles or powders, or metal carbides, or other useful drilling material to the base metal by any conventional means known in the prior art.

The burs may be made to any suitable dimensions. The Figures illustrate the shaft dimensions at about 1/16 inch diameter, or alternately 1.6 mm diameter, a commonly used size for popular power driven handsets. Since the burs are to be used in a manner where the axis of rotation is approximately perpendicular to the working surface of the tooth, and in this mode access is limited, the overall length should not be excessive.

The diameter of the base of the cone should be between about 1 mm and 10 mm. In a preferred embodiment, the diameter of the base of the cone is between about 2 and 4 mm. The angulation of the cone may be between about 30° and 150° at the apex. In a preferred embodiment, the angulation of the cone is between about 60° and 120°, with a most preferred angle between about 70° and 100°.

The extent of the conical surface covered with abrasive material may also be varied over a wide range, where coverage of between about 20% and 90% of the surface area may be employed. Multiple burs with coverage within this range give the dental practitioner additional flexibility and choice to use in a given situation.

Although the foregoing embodiments of the present invention have been described in some detail by way of illustration and example for purposes of clarity and understanding, it will be apparent to those skilled in the art that certain changes and modifications may be practiced within the spirit and scope of the present invention. Therefore, the description and examples presented herein should not be construed to limit the scope of the present invention, the essential features of which are set forth in the appended claims.

I claim:

1. Dental burs for shaping teeth with composite fillings comprising:
a first bur provided with a first shaft,
a proximal end of said first shaft formed for removable attachment to a power drive handset
an opposite distal end of said first shaft,
a first conical bur head coaxially secured to said distal end of the first shaft,
an abrasive surface end portion of said first conical bur head, and
a non-abrasive surface portion at the base of the outward conical surface of said first conical bur head;
and
a second bur provided with a second shaft,
a proximal end of said second shaft formed for removable attachment to a power drive handset
an opposite distal end of said second shaft,
a second conical bur head coaxially secured to said distal end of the said second shaft,
a non-abrasive surface end portion of said second conical bur head, and
an abrasive surface portion at the base of the outward conical surface of said second conical bur head.

2. The burs according to claim 1 where the angle of said conical bur heads are between 30 and 150 degrees at the apex.

3. The burs according to claim 1 where the angle of said conical bur heads are between 60 and 120 degrees at the apex.

4. The burs according to claim 1 where the angle of said conical bur heads are between 70 and 100 degrees at the apex.
